(19) United States
(12) Patent Application Publication
(10) Pub. No.: US 2007/0298389 A1
(43) Pub. Date: Dec. 27, 2007

(54) System presenting step by step mathematical solutions

(75) Inventors: Jinsong Yu, Sammamish, WA (US); Luke G. Kelly, Bellevue, WA (US); Seth R. Atkinson, Redmond, WA (US); William B. Kunz, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/448,525

(22) Filed: Jun. 7, 2006

(51) Int. Cl. G09B 19/02

(52) U.S. Cl. 434/188

(57) ABSTRACT

A system is disclosed for generating and displaying intermediate steps in an educational computer algebra system. The system combines templates with an algorithm to generate intermediate steps and explanatory text which may be displayed to the user.

### BACKGROUND

Software application programs are known for teaching mathematics to all levels of students. One of the most popular is for teaching algebra. Computer algebra systems (including algebra application programs, graphing calculator application programs, and handheld graphing calculators) perform mathematical calculations and solve equations, and then display the final results. However, there are presently no useful computer algebra systems which display the intermediate steps to show how the final results are obtained. The intermediate steps have important educational value, especially for students learning the mathematical concepts and procedures. Often, the final result is not very useful to students without the intermediate steps.

It is technically difficult for computer algebra systems to show the intermediate steps for several reasons. Many algorithms and procedures employed by computer algebra engines use different approaches to solve mathematical problems than human beings do. Typically when people solve a mathematical problem, they may analyze the problem and then use trial-and-error to attempt different strategies. They will likely try to avoid complicated calculations if possible, and they may use heuristics to apply special techniques to make the procedure simpler if the problem has some special patterns. Moreover, the same mathematical problem may also be solved in completely different ways to get the same result, and depending on the topic that the students are currently learning, the students may be expected to use a certain strategy to solve a problem, or sometimes they may be expected to use multiple strategies to solve the same problem.

On the other hand, computer algebra engines use algorithms and procedures that can be applied to broad and general cases. Complicated calculations are not a problem, and there is no need to make the procedure simpler when the user input has special patterns. If a first strategy covers all problems that a second strategy can solve, most likely the second strategy is omitted from the computer algebra engine implementation entirely.

A typical example is solving linear equation systems. Students generally learn to do this in at least three ways: by substituting the variables, by adding and subtracting equations, and by using matrix computations. The first two techniques are typically learned long before they learn to use matrix computations. However, since solving linear equations by matrix computation is the broadest and most general case, and all linear equations systems can be solved by using matrix computation, most computer algebra engines implement only this method and not the other two.

As the approaches that computer algebra engines use to solve mathematical problems are different than the approaches that human beings use, showing the intermediate steps used by the computer algebra engine would look unnatural and even bizarre in many cases. This would effectively defeat the purpose of showing the intermediate steps. And because computer algebra engines use a single method to obtain the final result, they could not show intermediate steps for multiple strategies.

Another shortcoming of conventional algebra engines is the inability to provide explanatory text. Even if intermediate steps were provided, merely listing the steps is not as effective a teaching tool as listing the steps together with explanatory text.

### SUMMARY

Embodiments of the present system in general relate to methods for generating and displaying intermediate steps in a computer algebra system. The present system combines stored templates with an algorithm for matching and applying the templates to inputs from a user of mathematical problems. Upon inputting a mathematical problem, the algorithm of the present system searches for one or more templates that match the form of the inputs. The templates include code for displaying intermediate steps for solving the input problem, including the intermediate mathematical expressions that lead to the solutions and explanatory text. Once a proper matching template is identified, the template is materialized with information from the user input, and then the intermediate steps from the template may be generated from the template and displayed to the user.

An embodiment of the present system includes an application program having an algebra engine. The algebra engine includes a plurality of known components for performing known functions of algebra engines. In addition to the known components used in an algebra engine, the engine may further include a matching engine for matching a user input to a template, and a materialization engine for materializing, or populating, a template with numerical expressions and/or text for display of the intermediate steps.

In operation, once launched, the application program prompts a user to enter an algebra problem. The algebra engine parses the user input. Thereafter, the matching engine cycles through the templates to find one or more matches to the input. Upon completion, if no matches are found, the application program displays the final result. On the other hand, if one or more matching templates were identified, the algebra application displays the final result along with a link to each matching template identified.

If a user selects a link to an identified template, the materialization engine materializes the selected template with values from the input and explanatory text. As the present system may be used in multilingual settings, in embodiments, the templates may not themselves include the text to be displayed. Instead, the templates may include text IDs from which actual, localized text may be retrieved from text files. Thus, multilingual text may be pulled from different databases to provide the explanatory text accompanying the numerical expressions in the displayed intermediate steps.

While embodiments of the present system relate to step-by-step instructions for solving problems that are handled in a typical computer algebra system implementation, including arithmetic, elementary algebra, equation solving, linear algebra, statistics, trigonometry, and calculus, etc, it is understood that the present system may be used for solving mathematical problems in a wide variety of other math disciplines. Such additional disciplines include geometry, graphing, and word problems, etc.

### DESCRIPTION OF THE DRAWINGS

FIG. 1 is a software block diagram of an embodiment of the present system.

FIG. 2 is a flowchart of the overall operation of embodiments of the present system.

FIG. 3 is a flowchart illustrating a matching operation for identifying templates that match a user input.

FIG. 4 is an illustration of a tree structure into which a template matching expression and a user input may be parsed.

FIG. 5 is a flowchart illustrating a materialization operation for populating a template with the information needed to display intermediate steps in reaching the solution to a mathematical problem.

FIG. 6 is a block diagram of hardware components on which embodiments of the present system are capable of operation.

### DETAILED DESCRIPTION

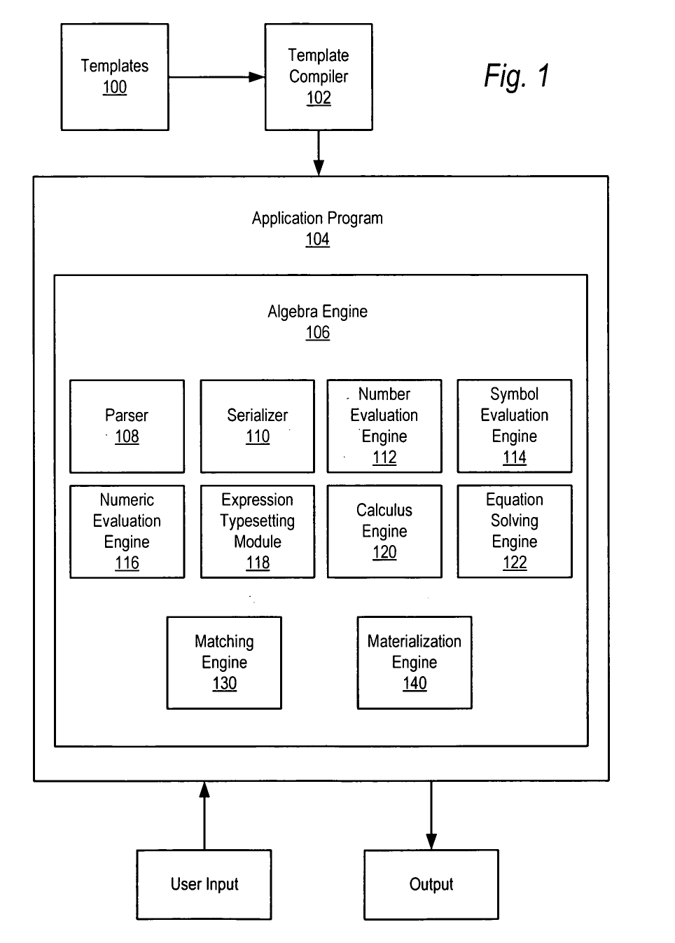

Embodiments of the present system will now be described with reference to FIGS. 1-6, which in general relate to a system and method for generating and displaying intermediate steps in an educational computer algebra system. The present system is described hereinafter typically with respect to an application program including an algebra engine for solving algebra problems. However, as will be explained, the present system may in general be used for application programs directed to solving math problems in a wide variety of other mathematical disciplines.

The present system combines stored templates with an algorithm for matching and applying the templates to user inputs to generate intermediate steps in the solution of a math problem. In general, upon inputting a mathematical problem, the algorithm of the present system searches for one or more templates that match the form of the inputs. The templates include code for displaying intermediate steps for solution of the input problem, including the intermediate expressions for the solutions and explanatory text. Once a proper matching template is identified, the template is populated, or materialized, with information from the user input, and then the intermediate steps from the template may be generated from the template and displayed to the user.

The following description relates to the composition of the templates. As equations may include any number of variables and terms, there are in fact an infinite number of equations and mathematical problems which may be posed. As such, the number of templates which may be generated and stored is also limitless. However, in embodiments, templates are generated and stored covering any mathematical problem a student is likely to be presented with, though it is understood that the number of templates may be lesser or greater than that in alternative embodiments.

Moreover, it is understood that a given equation may be written in several different forms. For example, the expression “2x+4y−6=0” may alternatively be expressed “2x=−4y+6.” Thus, a single equation may have several different templates devoted to it, each expressing the equation in different forms.

As indicated in the software block diagram of FIG. 1, the templates 100 may be created as XML files, and then compiled into a binary file which is embedded in an algebra engine 106 explained hereinafter. Each template may be separated into two distinct parts: a rule part and a display part. The rule part of the template specifies the matching expression, conditions, and intermediary variables in an XML format. The algebra engine 106 uses the rule portion of templates to determine what templates match with a given input, as explained hereinafter. The algebra engine 106 also uses the rule portion of the template to evaluate the user input coefficients and intermediary variable values, explained hereinafter. The part of the application program that handles display then uses the coefficients and intermediary variable values together with the display template to produce the final display.

The rule portion of a template 100 specifies a matching expression in XML format, though other formats are possible. As explained hereinafter, the matching expression is parsed by the algebra engine 106 into a tree structure usable by the algebra engine. The user input is similarly parsed into a tree structure, so that the algebra engine may compare the user input against the template matching expressions to find those templates that match the user input.

The rule portion of a template 100 may further include conditions in an XML format, though other formats are possible. The conditions specified in the rule portion of the templates may be used in addition to the matching expression to further pair down the list of what templates can be used for a given input. After a matching template is found, the algebra engine 106 uses the rule portion of the template to evaluate coefficients and the intermediary variable values.

The rule portion of a template 100 may further specify intermediary variables that are to be determined by the algebra engine 106. In particular, intermediate steps typically involve conversion and/or simplification of the original input problem. This conversion and/or simplification typically involve the use of one or more intermediary variables that are specified by the author and built into the template. These intermediary variables are solved for and used in the display of the intermediate step. The role of intermediary variables is explained in greater detail hereinafter.

Each rule template portion may be assigned its own unique name, and the name may match with the corresponding display template portion. When an author creates a template, a command line utility can be used to verify the XML format, and the tool will generate error messages if it finds incorrect formats or inconsistencies in the rule template. The same command line utility may be used by a developer to compile the XML file into a binary file as indicated below.

Below is an example of a rule portion of a template 100 showing the format of the rule template portion. The requirements of the different parts are explained below. A complete rule template XML file may be as follows:

```
<?xml version=“1.0” encoding=“utf-8” ?>
<Templates>
  <Template Name=“Equation.Linear.1” ApplyOnReal=“1”>
    <Variables>
      <Variable Name=“x” />
    </Variables>
    <Match>solve( c(a x + b) + d = f, x )</Match>
    <Condition> not(a=0) and not(c=0) </Condition>
    <Values>
      <Value> t1 := f − d </Value>
      <Value> t2 := t1 / c </Value>
      <Value> t3 := t2 − b </Value>
      <Value> t4 := t3 / a </Value>
    </Values>
  </Template>
</Templates>
```

The root element may be <Templates>. There can be multiple <Template> elements in the same file, although separate XML files may be created for each template. The file name may be in the format of “xyz.Rule.xml”, and the same template name may be used in the file name, so for the above example, the file name may be “Equation.Linear.1.Rule.xml”.

In the above example, the Template element has an ApplyOnReal=“1” attribute. A template can have either ApplyOnReal=“1”, or ApplyOnComplex=“1” or neither. If neither is there, the template can be used in both the real number field and the complex number field. If one of them exists, then the template is used in that number field.

The Variables/Variable elements are used to specify “principal variables”. All variables that are not principal variables are coefficients. For equation solving, the principal variables are the same as the solve-for variable list. There can be multiple Variable elements under Variables. An example would be to solve a linear equation system.

The matching expression contains the linear syntax of the input expression. Implied coefficients may be used in addition, subtraction, multiplication and division, but not in other types of expressions. For example, the user input “3x+5=2” will match to the template shown above, with implied coefficients a=1 and b=0. Implied coefficients may be omitted in alternative embodiments.

The condition element specifies a match condition, and may be omitted from a template. One or more of the following conditions may be used in the condition: “and”, “or”, “not”, “xor”, “=”, “>”, “<”, “>=”, “<=”, “is Int”, “is Fraction”, “is Number”, “is Even”, “is Odd”, “is Real”, “is Complex”, “is Rational”, “is Atom”, “is Const”, “is VariableFree” “in {_comma_delimited_list_here}”. Other conditions are contemplated.

Values/Value elements specify the intermediary variables. Each Value element may be an assignment, and it can use the coefficients specified in the Match expression, or other intermediary variables defined before the current one.

The display portion of a template contains an indication of the text to be displayed in the intermediate step. In embodiments, as explained hereinafter, the present system may be used in different language speaking countries. Accordingly, instead of hard-coding actual text into the display portion of the templates, the templates may include a text ID which identifies specific text. At runtime, the application program uses the text ID to look up the specific, localized text from a database associated with the user computing system.

The display portion of the template may also specify what parameters are to be displayed along with actual text in the intermediate step. For example, the display portion of the template may include a text ID which calls localized text:
“Next, add {0} and {1} together.”
   Here, {0} and {1} are parameters. They may be given by the original user input or they may be given by intermediary variables specified in the template. Thus, in this example, the parameters may evaluate to 3 and 0.5 (as an example). Thus, the intermediate step is displayed as:
“Next, add 3 and 0.5 together.”

The display portion of a template may also contain information relating to a conditional statement (if . . . then . . . else), and flow controls (goto and call statements) as explained hereinafter.

A description of the architecture of the present system will now be explained with reference to FIG. 1. As indicated above, the templates 100 may be created as XML files, and then compiled by a compiler 102 into a binary file which is embedded in the algebra engine 106 to be used at runtime. If the template compiler 102 detects any syntax error in the template XML files, the errors are reported and the binary file is not generated.

Embodiments of the present system include an application program 104 having an algebra engine 106. Algebra engine 106 may perform the significant portion of the present system, including matching an input to a template and materializing the template. Other portions of the application program 104 may be responsible for interacting with the graphical user interface to receive input from the user and to display the results and intermediate steps generated by the algebra engine 106 according to embodiments of the present system.

Algebra engine 106 includes a plurality of known components for performing known functions of algebra engines. For example, the Parser 108 is provided to parse user input into a tree structure usable by the algebra engine 106 for solution of the problem. The parsed tree structure also allows matching of the input to the stored templates, which include template matching expressions parsed into a similar tree structure as explained hereinafter.

Serializer 110 is used to serialize the tree structure into various text representations that can be understood by a human or by other software components that are responsible for displaying the math formulas. Number Evaluation Engine 112 evaluates various operations on numbers symbolically (without round off errors). Examples of such evaluations include:

½+⅓=⅚

sqrt(8)=2*sqrt(2)

Symbol Evaluation Engine 114 evaluates operations on generic algebraic expressions symbolically (without round off errors) examples include:

sin(x)/cos(x)=tan(x)

(ê2+e)/e=e+1

Numeric Evaluation Engine 116 evaluates operations on numbers and constants numerically and generates approximate answers (possibly with round off error). Examples include:

Log(5)=0.698970004336

23\hat{0}45=1.8956258430116*10\hat{0}61

Expression Typesetting Module 118 formats an expression into a reasonable format that is generally used in text books or math publications. Such formatting procedure includes the steps of putting the terms in reasonable order (e.g., “2a x\hat{0}2” instead of “x\hat{0}2*2a”), and the right placement of terms in fractions (e.g. “x/2” instead of “½*x”), as well as the correct placement of a minus sign (e.g.

$$“ - \frac{1}{2} ”$$

instead of

$$“ \frac{- 1}{2} ”$$

etc). This is independent of the serializer module 110. Typesetting Module 118 operates on the tree structure and therefore occurs before serialization.

Calculus Engine 120 evaluates calculus related expressions, including derivatives, integrations, limits, etc. Examples include:

$$\frac{d}{d x} ( sin ( x ) ) = cos ( x )$$

$${\int }_{0}^{x} {e}^{t} d t = {e}^{x} - 1$$

$${\sum }_{n = 1}^{∞} \frac{1}{{n}^{2}} = \frac{{π}^{2}}{6}$$

Equation Solving Engine 122 solves equations both symbolically (without round off errors) and numerically (possibly with round off errors).

### Examples Include:

$$solve ( {x}^{⋀} 2 + 3 x - 5 = 0 ) \text{:}$$

$$\begin{matrix}x = \frac{\sqrt{29} - 3}{2} \\ \approx 1.1925824035673\end{matrix} , \begin{matrix}x = \frac{- \sqrt{29} - 3}{2} \\ \approx - 4.1925824035673\end{matrix}$$

It is understood that algebra engine 106 may include additional and/or alternative known components for algebra engines to those described above in further embodiments.

The algebra engine 106 may further include a matching engine 130 for matching a user input to a template, and a materialization engine 140 for materializing a template with numerical expressions and/or text for display of the intermediate steps. The matching engine 130 and the materialization engine 140 are explained in greater detail hereinafter.

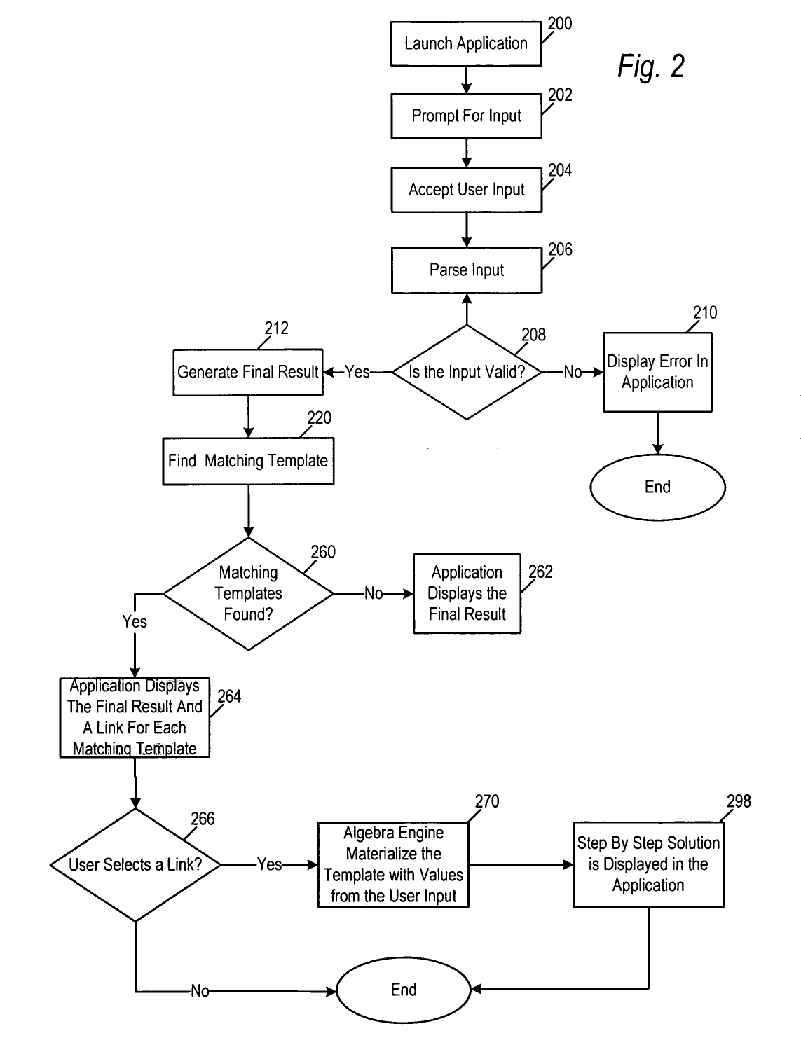

The overall operation of the present system will now be explained with reference to the flowchart of FIG. 2. Application program 104 including templates 100 may be loaded into memory on a computing device (a suitable embodiment of which is explained hereinafter). The computing device may include a monitor and input selection devices such as a keyboard and mouse or other pointing device. Once application program 104 is launched in step 200, the application program provides a graphical user interface over the monitor for prompting a user to enter a mathematical problem in step 202. The user may enter the problem via the input selection devices and graphical user interface in step 204.

In step 206, the algebra engine 106 parses the received user input. Thereafter, the algebra engine evaluates the input in a step 208 in a known manner and determines whether the input is valid. If not, the algebra engine displays an error message over the graphical user interface in step 210. If the input is found to be valid in step 208, the final result is generated in step 212.

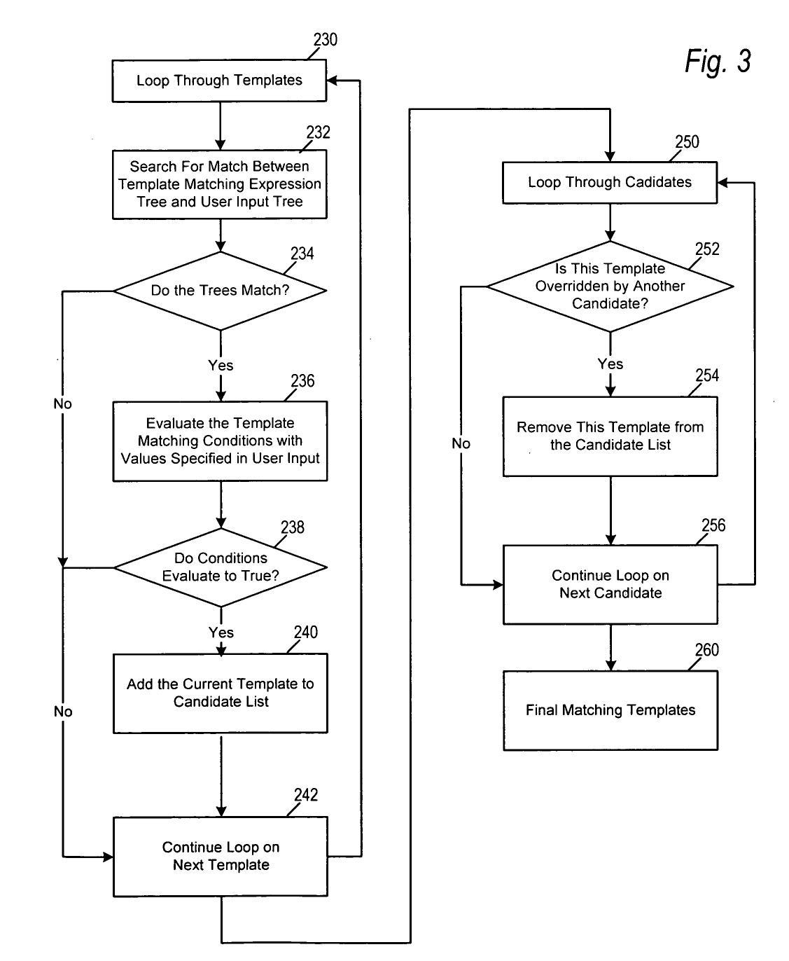

After an input is validated, in addition to generating the final result, the application program 104, and in particular matching engine 130, searches for matching templates in step 220. Step 220 is explained in greater detail with respect to the flowchart of FIG. 3. As indicated above, both user inputs and template matching expressions are parsed and stored in memory as tree structures. In order for the matching engine 130 to determine whether the user input matches with a template, the engine loops through each template (step 230) and performs a recursive matching on the input and template matching expression trees starting from the root (step 232).

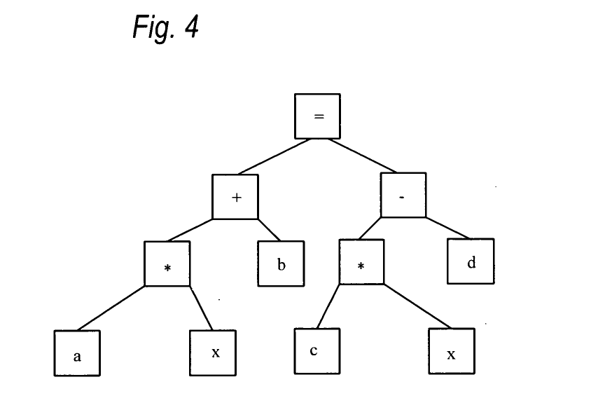

For instance, FIG. 4 shows an example of how a tree structure might look for a template matching expression for the equation “ax+b=cx−d.” The matching expression may include template coefficients and principal variables. Template coefficients are matched with coefficients in the user input. Template principal variables match with variables in the user input. In the above example, a, b, c and d are template coefficients and x is the principal variable. The tree structure includes nodes 224 having operands such as +, *, =, and nodes 226 having principal variables and coefficient variables. The operand nodes 224 will branch downward into the principal variable and coefficient variable nodes 226.

The user input is parsed into a similar tree structure. In step 232, the matching engine inspects the root node of the user input, here “=”, and rejects it if there is not a match. The matching engine then walks down all branches of the trees for both the parsed input and parsed template matching expression in step 234 and performs a matching comparison node by node. If there is a mismatch at any node, the template is rejected as a match.

There are different flags in the template to specify what in the user input can be matched to a variable in the template matching expression. The node 226 in the matching expression input tree containing the “a”, “b”, “c” and “d” can for example be wildcards that may be matched to any coefficient in a corresponding node of the user input tree. In embodiments, nodes in the stored template matching expression tree containing actual number coefficients may only match those same coefficients in the input tree nodes.

In the event a given wildcard in the template matching expression is matched to a coefficient in the input tree, then that wildcard is assigned that coefficient. In the event that the same wildcard appears twice in a template matching expression, then the input must have the same two coefficients in the corresponding nodes, or there is no match. For example, a template matching expression “ax+ay=b” would not match an input expression “2x+3y=b”.

As indicated above, in order to make the templates 100 more general, implied coefficients may be allowed during matching. For example, user input “3x” may match template matching expression “ax+b” where a=3, x=x, and b=0 is an implied coefficient.

If a given template is found not to match the input in step 234, the matching engine loops to step 244 to check if there is another template to check. If there is, the matching engine loops to the next template in step 230. Assuming a template matching the input is found, the algebra engine 106 evaluates any matching conditions in the template in step 236. In particular, as mentioned above, a template may include conditions relating to the expression represented by the template. The conditions may be a variety of different requirements which must be true in order for there to be a match between the input and template. A further partial listing of possible conditions is set forth above. As a further example, the algebra engine may check for specific values which a term in the template must have, or not have, such as “not(a=0)”.

The algebra engine 106 checks whether all conditions for a given template evaluate true for a given input in step 238. If any conditions for a template are not met, that template is dismissed as a possible match, and the algebra engine skips to step 242 to check for a next template. If a template's matching expression matches with the user input (step 234), and any matching conditions in the template are satisfied for the input (step 238), then that template is added to a stored listing of candidate matches for the input in step 240.

After the computer algebra engine iterates through all templates in step 242 and finds all candidate matches, the algebra engine next checks for overriding relationships among the candidates in step 250. In particular, sometimes the same problem can be solved in different ways, and therefore multiple templates can match with the same user input. If the templates are using different strategies, they may all be shown to the user so that the user can choose which one to use. However, at times a template A and a template B are solving the same problem using the same strategy, but template A is more general (applying to broader cases). Template B is more specific and its usage is narrower, but because of the special constraints on template B, template B uses fewer steps and is more straightforward and easier to follow. In this case, when templates A and B both match with a given user input, template A may be hidden and only template B shown as a candidate.

In order to handle this situation, templates can specify override flags (<Hide> elements in the template file format). The computer algebra engine 106 iterates through the candidates (step 250), and the algebra engine checks to see if one candidate is overridden by another candidate (step 252). If one candidate is overridden by another candidate, the overridden template is removed from the candidate list in step 254.

Once a candidate is checked for its override flags, the algebra engine checks if there are further candidates to test for the override in step 256. If so, the engine loops back to step 250 to check the next candidate. Otherwise, the final list of matching templates is stored in step 260. It is understood that the feature of override flags, and steps 250 through 256 relating thereto, may be omitted in alternative embodiments so that both candidates (templates A and B in the above example) remain as matching templates to the input.

Returning again to the overall operational flowchart of FIG. 2, the algebra engine 106 checks in step 260 whether one or more matching templates for a given input have been found. If not, the application program 104 displays the final result on the graphical user interface in step 262. On the other hand, if one or more matching templates were identified in step 220, the application program 104 displays the final result along with a link to each matching template identified in step 220 on the graphical user interface in step 264. The link itself may be any of several forms indicating that intermediate steps are available for display to aid the user in understanding the solution to the problem.

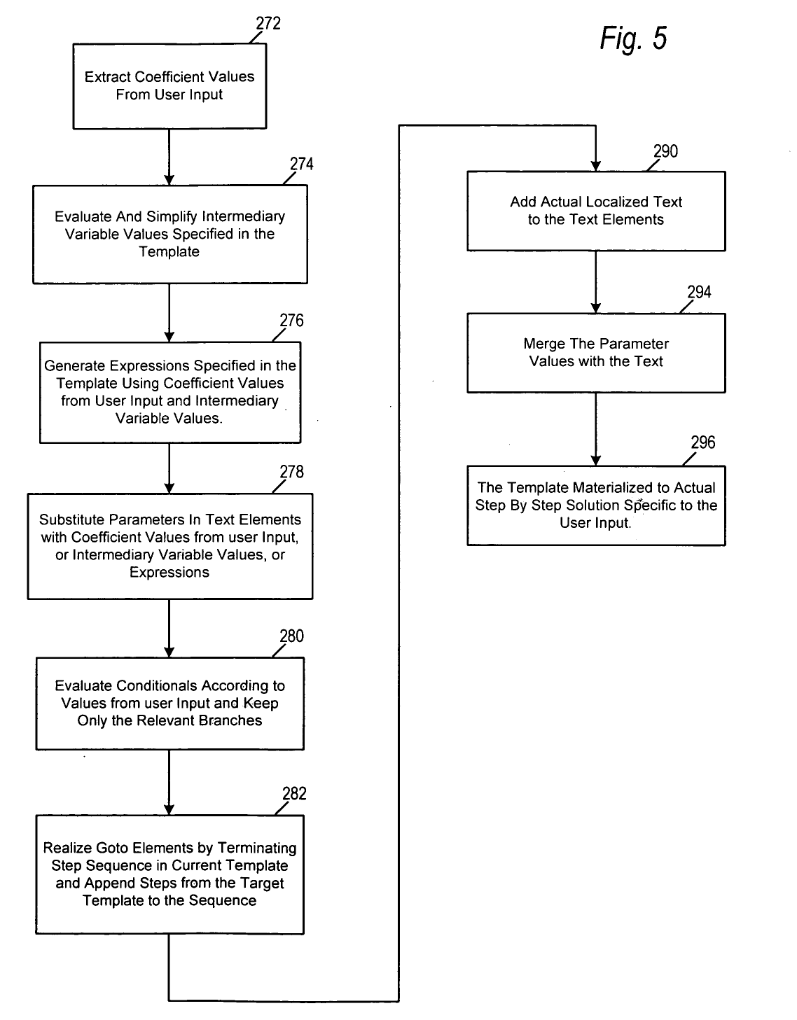

In step 266, the algebra engine 106 checks whether a user selects one of the links in step 264. If not, the algebra engine performs no further functions for the input and displays the solution over the graphical user interface. On the other hand, if a user selects a link displayed in step 264, the materialization engine 140 of algebra engine 106 materializes the template with values from the input and/or any intermediary variable values in step 270. Further details of step 270 are shown in the flowchart of FIG. 5.

The templates 100 contain the general procedure but not specific coefficient values from user input. A matching template, when selected, must therefore be materialized by “plugging” values from user input and/or intermediary variables into the template before the intermediate steps specified by the templates can be displayed. As used herein, the terms materialize and populate are used interchangeably. In embodiments of the present system, the materialization may happen in four general steps. The first three steps may be performed by the computer algebra engine 106 and the last step may be performed by the application program 104 communicating with the graphical user interface.

In general, the first step processes and simplifies all intermediary variable values defined in the template using coefficient values from user input. In particular, a template may specify that an input equation is to be processed into an intermediate form, or expression, which is to be used for explanation purposes in the intermediate step. The intermediate expression may require the calculation and use of intermediary variables. An example is set forth below, but it is understood that any number of expressions and intermediary variables may be specified in various templates for use in generating the display of the intermediate step(s).

Accordingly, in step 272, the algebra engine 106 extracts the coefficient values from the user input and assigns them to the corresponding variables or wildcards, if any, in the template. Any intermediary variables are then processed and simplified in step 274. As an example, assume a matching expression in a template is “a x\hat{0}2+b=c”, and user input is “2 x\hat{0}2 +3=21”. In step 272, the algebra engine will assign the coefficients 2, 3, 21 to the wildcard coefficients a, b, c, respectively.

In this example, the template may specify several intermediate steps such as:
Step 1: “a x\hat{0}2=p”. This is an expression, where p is an intermediary variable which is specified in the template to be “p=c−b”.
Step 2: “x\hat{0}2=q”. This is an expression, where q is an intermediary variable which is specified in the template to be “q=p/a”.
Step 3: “solution 1: x=s, solution 2: x=t”. This is an expression, where s and t are intermediary variables which are specified in the template to be “s=sqrt(q),” and “t=−sqrt(q)”.
   During the materialization of the template in step 274, the algebra engine will do the following:
p is assigned to “21−3” and simplified into 18.
q is assigned to “18/2” and simplified into 9.
s is assigned to “sqrt(9)” and simplified into 3.
t is assigned to “−sqrt(9)” and simplified into −3.

The second general step (step 276) is to generate the expressions using coefficient values from user inputs and the intermediate variable values. In particular, any expressions specified in the template may include intermediary variables. The intermediary variables processed and simplified in step 274 are inserted into the expressions. Thus continuing with the above example, the following expressions are generated in the various steps:
Step 1: “2 x\hat{0}2=18”
Step 2: “x\hat{0}2=9”
Step 3: “solution 1: x=3, solution 2: x=−3”.

The intermediate variables and expressions are used to designate what is simplified and what is not. In particular, intermediary variables are simplified, but expressions are not. Simplifying the expressions would result in simply reaching the final solution, and there would be no intermediate steps to display. Thus, the expression designated in a template is displayed, with all original inputs inserted where applicable and with all intermediary variables simplified as set forth above and inserted.

The third general step is to process the display flow using the display portion of a template 100, as explained below in steps 278 through 282. The display flow is specified in the template with any number of elements, including for example text elements, expression elements, conditional elements (if . . . then . . . else), goto elements (to terminate display flow in current template and continue from another template), and formatting constructs such as indicating a new line and new step.

As indicated above, text elements to be included in the display of the intermediate steps may or may not include parameters. Namely, the text display of the intermediate step may include the display of a user defined value (from the original input), a calculated value (from an intermediary variable) or an expression. If there are text parameters, the computer algebra engine may substitute in the actual values for the parameters in step 278.

In step 280, any conditionals are evaluated according to the values from user input and only the relevant branches are kept in the actual steps. In particular, an intermediate step may become irrelevant because terms (implied or otherwise) zeroed out, or because a condition to be satisfied in order for an intermediate result to be relevant was not in fact satisfied. If it turns out that one or more of the intermediate steps are not relevant to a particular input, these intermediate steps would not be displayed. In alternative embodiments, the algebra engine may display the irrelevant intermediate step with an indication that it is not relevant and why it is not relevant.

A template may indicate that intermediate steps from another template should be included, either in the normal course of operation or if certain conditions are true. Therefore, templates may include goto elements that indicate which additional template(s) and, if necessary, which intermediate step(s) of the additional template(s), are to be displayed. In step 282, any goto elements may be executed by appending the steps in the target template to the current step sequence.

After the third general step described above in steps 278 through 282, the one or more intermediate steps are ready for display, except that the actual text needs to be imported, depending on a language specified by the user. As mentioned above, in order to use the present system in international markets, the text may be localized into different languages. The computer algebra engine 106 may be kept language neutral, and only the application executable needs to be localized. Therefore, in step 290, the application program 104 uses the text ID specified in a template for a given intermediate step to look up the specific, localized text from a database associated with the user computing system. It is understood that actual text may be hard-coded into a template in alternative embodiments instead of retrieving localized text with text IDs.

In step 294, the parameter values of the text element are merged with the actual text. At this point, the template is completely materialized to the actual step-by-step solution specific to the user input and it can be displayed.

Returning to the overall operational flowchart in FIG. 2, once the template is materialized with all parameters as described above, the step-by-step solution may be displayed over the graphical user interface in step 298 by the application program 104.

The description above relates to generating and displaying step-by-step instructions for solving problems that are handled in a typical computer algebra system implementation, including arithmetic, elementary algebra, equation solving, linear algebra, statistics, trigonometry, and calculus, etc. However, it is understood that the present system may be used for solving mathematical problems in a wide variety of other math disciplines. Such additional disciplines include geometry, graphing, and word problems, etc.

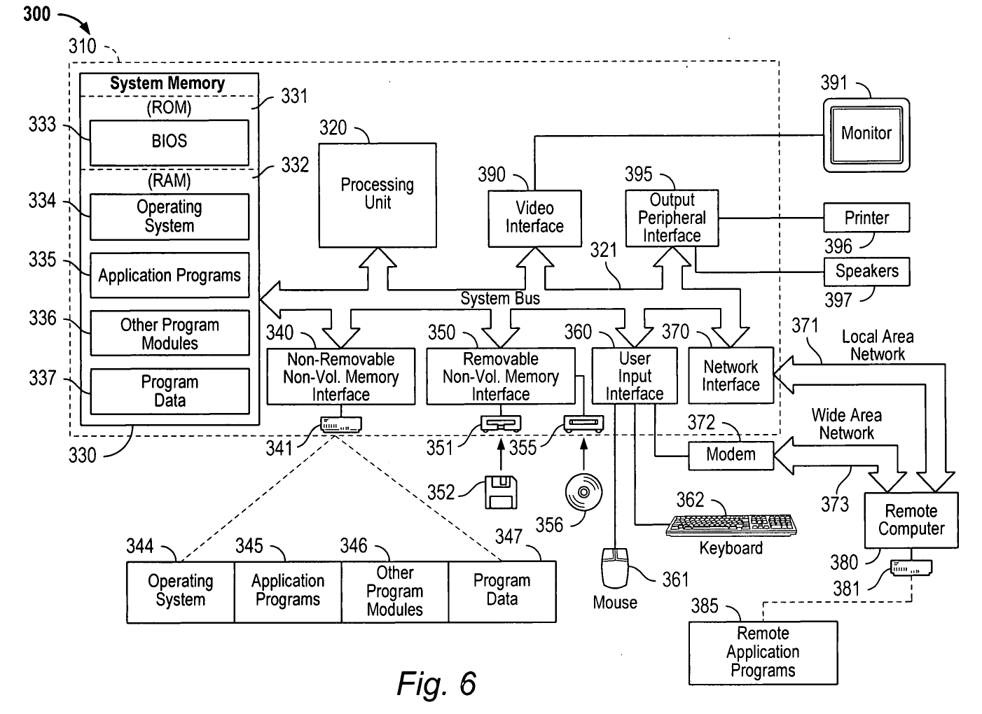

FIG. 6 illustrates an example of a suitable general computing system environment 300 that may comprise any processing device shown herein on which the inventive system may be implemented. The computing system environment 300 is only one example of a suitable computing environment and is not intended to suggest any limitation as to the scope of use or functionality of the inventive system. Neither should the computing system environment 300 be interpreted as having any dependency or requirement relating to any one or combination of components illustrated in the exemplary computing system environment 300.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 6, an exemplary system for implementing the inventive system includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 may include a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 330 includes computer storage media in the form of volatile and/or nonvolatile memory such as ROM 331 and RAM 332. A basic input/output system (BIOS) 333, containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 6 illustrates operating system 334, application programs 335, other program modules 336, and program data 337.

The computer 310 may also include other removable/non-removable, volatile/nonvolatile computer storage media. By way of example only, FIG. 6 illustrates a hard disc drive 341 that reads from or writes to non-removable, nonvolatile magnetic media and a magnetic disc drive 351 that reads from or writes to a removable, nonvolatile magnetic disc 352. Computer 310 may further include an optical media reading device 355 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 341 is typically connected to the system bus 321 through a non-removable memory interface such as interface 340, magnetic disc drive 351 and optical media reading device 355 are typically connected to the system bus 321 by a removable memory interface, such as interface 350.

The drives and their associated computer storage media discussed above and illustrated in FIG. 6, provide storage of computer readable instructions, data structures, program modules and other data for the computer 310. In FIG. 6, for example, hard disc drive 341 is illustrated as storing operating system 344, application programs 345, other program modules 346, and program data 347. These components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and a pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 6. The logical connections depicted in FIG. 6 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communication over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 6 illustrates remote application programs 385 as residing on memory device 381. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of generating one or more intermediate steps in the solution of a mathematical problem from user input in a computing system, comprising the steps of:
(a) matching the mathematical problem to a template designed to provide the one or more intermediate steps for the mathematical problem;
(b) specifying at least one procedure in the template from which the one or more intermediate steps may be generated; and
(c) populating the template with information from which at least one procedure in said step (b) may generate the one or more intermediate steps.

2. The computer implemented method recited in claim 1, wherein said step (b) of specifying at least one procedure in the template from which the one or more intermediate steps may be generated comprises the step of specifying intermediary variable values derived from coefficient values of the mathematical problem from user input.

3. The computer implemented method recited in claim 1, wherein said step (b) of specifying at least one procedure in the template from which the one or more intermediate steps may be generated comprises the step of specifying intermediate expressions derived from the mathematical problem from user input.

4. The computer implemented method recited in claim 3, wherein said step (b) of specifying at least one procedure in the template from which the one or more intermediate steps may be generated comprises the step of specifying intermediate expressions derived from intermediary variable values specified in the template and derived from coefficient values in the mathematical problem from user input.

5. The computer implemented method recited in claim 1, wherein said step (b) of specifying at least one procedure in the template from which the one or more intermediate steps may be generated comprises the step of specifying one or more text IDs for text to be obtained from a text file and used in the one or more intermediate steps.

6. The computer implemented method recited in claim 1, wherein said step (c) of populating the template with information comprises the step of using one or more coefficient values from the mathematical problem from user input to generate the information.

7. The computer implemented method recited in claim 1, wherein said step (c) of populating the template with information comprises the step of using intermediary variable values specified by the template to generate the information.

8. The computer implemented method recited in claim 1, wherein said step (a) of matching the mathematical problem to a template comprises parsing an expression of the input mathematical problem and comparing the parsed expression of the input mathematical problem against a parsed expression of a mathematical problem from the template.

9. A computer implemented method of generating one or more intermediate steps in the solution of a mathematical problem from user input in a computing system, comprising the steps of:
(a) matching the mathematical problem to a template designed to provide the intermediate steps for the mathematical problem;
(b) determining one or more intermediary variable values specified by the template using one or more coefficient values in the mathematical problem from user input;
(c) specifying one or more expressions to be used in the one or more intermediate steps; and
(d) substituting one or more coefficient values of the mathematical problem from user input and one or more intermediary variable values into the one or more expressions in the event the one or more expressions include parameters calling for coefficient values or intermediary variable values.

10. The computer implemented method recited in claim 9, wherein said step (a) of matching the mathematical problem to a template comprises parsing an expression of the input mathematical problem and comparing the parsed expression of the input mathematical problem against a parsed expression of a mathematical problem from the template.

11. The computer implemented method recited in claim 9, wherein said step (a) of matching the mathematical problem to a template further comprises the step of checking conditions specified in the template which may negate a match between the template and the input mathematical expression.

12. The computer implemented method recited in claim 9, further comprising the step of reviewing matches identified in said step (a), and rejecting a first match where the intermediate step embodied in the first match is the same as an intermediate step in a second match except that the intermediate step in the first match is more generalized than the intermediate step of the second match.

13. The computer implemented method recited in claim 9, further comprising the step of specifying one or more text IDs in the template, the text IDs identifying text in a plurality of different languages from at least one stored file of text to be included in the one or more intermediate steps.

14. The computer implemented method recited in claim 9, further comprising the step of generating a plurality of different templates capable of matching different expressions of the mathematical problem.

15. A computer-readable medium having computer-executable instructions for programming a processor to perform a method of displaying one or more intermediate steps in the solution of a mathematical problem from user input in a computing system, the mathematical problem including coefficients and/or variables, the method comprising the steps of:
(a) matching the coefficients and/or variables in the mathematical problem to a template designed to provide the one or more intermediate steps for the mathematical problem;
(b) specifying at least one procedure in the template from which the intermediate steps may be generated;
(c) populating the template with information from which at least one procedure in said step (b) may generate the intermediate steps; and
(d) displaying the one or more intermediate steps.

16. The computer-readable medium recited in claim 15, wherein said step (b) of specifying at least one procedure in the template from which the one or more intermediate steps may be generated comprises the step of specifying intermediate expressions derived from the mathematical problem from user input.

17. The computer-readable medium recited in claim 15, wherein said step (b) of specifying at least one procedure in the template from which the intermediate steps may be generated further comprises the steps of:
specifying intermediary variable values derived from the coefficients of the mathematical problem from user input; and
deriving the intermediate expressions from at least one of the intermediary variable values and the coefficients.

18. The computer-readable medium recited in claim 15, wherein said step. (c) of populating the template with information comprises the step of using the coefficients from the mathematical problem from user input to generate the information.

19. The computer-readable medium recited in claim 15, wherein said step (c) of populating the template with information comprises the step of using intermediary variable values specified by the template to generate the information.

20. The computer-readable medium recited in claim 15, wherein said step (a) of matching the mathematical problem to a template comprises parsing the variables, coefficients, and operators from the input, and comparing the variables, coefficients, and operators against a parsed expression of a mathematical problem from the template.
